(19) United States
(12) Patent Application Publication
(10) Pub. No.: US 2024/0416766 A1
(43) Pub. Date: Dec. 19, 2024

(54) SERIES-PARALLEL MIXED CHEMISTRY BATTERY SYSTEMS

(71) Applicant: GM Global Technology Operations LLC, Detroit, MI (US)

(72) Inventors: Shuonan Xu, Troy, MI (US); Hanho Yun, Oakland Township, MI (US); Jun-mo Kang, Ann Arbor, MI (US)

(21) Appl. No.: 18/333,917

(22) Filed: Jun. 13, 2023

(51) Int. Cl. B60L 50/60; B60L 58/13; B60L 58/18

(52) U.S. Cl. CPC B60L 50/66; B60L 58/13; B60L 58/18; B60L 2210/10; B60L 2240/547; B60L 2260/50

(57) ABSTRACT

In one exemplary embodiment, a system for controlling power transfer includes a propulsion battery assembly configured to supply power to an electric motor of a vehicle, the propulsion battery assembly having a first chemistry, and a supplemental battery assembly selectively connected to the propulsion battery assembly, the supplemental battery assembly having a second chemistry that is different than the first chemistry. The system also includes a controller configured to selectively connect the supplemental battery assembly to perform at least one of providing electrical charge to the propulsion battery assembly, and supplying electrical power to the electric motor.

### INTRODUCTION

The subject disclosure relates to energy or power storage and transfer, and more particularly to systems including multiple battery chemistries and methods for controlling operation of multi-chemistry energy storage systems.

Vehicles, including gasoline and diesel powered vehicles, as well as electric and hybrid electric vehicles, feature battery storage for purposes such as powering electric motors, electronics and other vehicle subsystems. Battery systems provide power to various loads, including electric motors for propulsion, and accessories and components such as power control modules, heaters and cooling systems. It is desirable to provide systems that can improve energy storage for purposes such as increased range and improved vehicle performance.

### SUMMARY

In one exemplary embodiment, a system for controlling power transfer includes a propulsion battery assembly configured to supply power to an electric motor of a vehicle, the propulsion battery assembly having a first chemistry, and a supplemental battery assembly selectively connected to the propulsion battery assembly, the supplemental battery assembly having a second chemistry that is different than the first chemistry. The system also includes a controller configured to selectively connect the supplemental battery assembly to perform at least one of providing electrical charge to the propulsion battery assembly, and supplying electrical power to the electric motor.

In addition to one or more of the features described herein, the system includes a third battery assembly including a battery cell having a third chemistry that is different than the first chemistry and the second chemistry, the battery cell connected in series to the propulsion battery assembly.

In addition to one or more of the features described herein, the supplemental battery assembly is a high energy battery assembly having an energy density that is greater than an energy density of the propulsion battery assembly.

In addition to one or more of the features described herein, the system includes a DC-DC converter connected in parallel to the propulsion battery assembly and the supplemental battery assembly, the DC-DC converter configured to adjust an output voltage of the supplemental battery assembly.

In addition to one or more of the features described herein, the controller is configured to connect the supplemental battery assembly in series to the propulsion battery assembly, and provide the electrical charge to the propulsion battery assembly through the DC-DC converter during vehicle propulsion to extend a range of the vehicle.

In addition to one or more of the features described herein, the controller is configured to connect the supplemental battery assembly based on a state of charge (SOC) of the propulsion battery assembly being below a SOC threshold, and provide the electrical charge to maintain the SOC of the propulsion battery assembly at or above the SOC threshold.

In addition to one or more of the features described herein, the controller is configured to connect the supplemental battery assembly in parallel to the propulsion battery assembly, and provide the electrical power to the electric motor through the DC-DC converter, the electrical power bypassing the propulsion battery assembly.

In addition to one or more of the features described herein, the vehicle is configured to be connected to a power source for charging of the propulsion battery assembly, and the controller is configured to control a charging process that prioritizes providing charging power to the propulsion battery assembly.

In addition to one or more of the features described herein, the charging process includes providing an amount of power to charge the propulsion battery assembly to a desired SOC, and providing a remaining amount of power to charge the supplemental battery assembly.

In addition to one or more of the features described herein, the controller is configured to control the charging process based on a predictive control methodology that includes predicting a state of charge of the propulsion battery assembly and the supplemental battery assembly based on a quasi-steady state model.

In another exemplary embodiment, a method of controlling power transfer includes monitoring, by a controller, a propulsion system of a vehicle, the propulsion system connected to a mixed chemistry battery system, the mixed chemistry battery system including a propulsion battery assembly configured to supply power to an electric motor of the propulsion system, and a supplemental battery assembly selectively connected to the propulsion battery assembly, the propulsion battery assembly having a first chemistry and the supplemental battery assembly having a second chemistry that is different than the first chemistry. The method also includes, based on receiving a request for additional propulsion, connecting the supplemental battery assembly and supplying additional power to the electrical motor, and based on a state of charge (SOC) of the propulsion battery assembly being below a SOC threshold, providing electrical charge to the propulsion battery assembly from the supplemental battery assembly.

In addition to one or more of the features described herein, the mixed chemistry battery system includes a third battery assembly including a battery cell having a third chemistry that is different than the first chemistry and the second chemistry, the battery cell connected in series to the propulsion battery assembly.

In addition to one or more of the features described herein, the supplemental battery assembly is a high energy battery assembly having an energy density that is greater than an energy density of the propulsion battery assembly.

In addition to one or more of the features described herein, the mixed chemistry battery system includes a DC-DC converter connected in parallel to the propulsion battery assembly and the supplemental battery assembly, the DC-DC converter configured to adjust an output voltage of the supplemental battery assembly.

In addition to one or more of the features described herein, providing the electrical charge to the propulsion battery assembly includes connecting the supplemental battery assembly in series to the propulsion battery assembly, and providing the electrical charge to the propulsion battery assembly through the DC-DC converter during vehicle propulsion to extend a range of the vehicle.

In addition to one or more of the features described herein, supplying the additional power includes connecting the supplemental battery assembly in parallel to the propulsion battery assembly, and providing electrical power to the electric motor through the DC-DC converter, the electrical power bypassing the propulsion battery assembly.

In yet another exemplary embodiment, a vehicle system includes a memory having computer readable instructions, and a processing device for executing the computer readable instructions, the computer readable instructions controlling the processing device to perform a method. The method includes monitoring, by a controller, a propulsion system of a vehicle, the propulsion system connected to a mixed chemistry battery system, the mixed chemistry battery system including a propulsion battery assembly configured to supply power to an electric motor of the propulsion system, and a supplemental battery assembly selectively connected to the propulsion battery assembly, the propulsion battery assembly having a first chemistry and the supplemental battery assembly having a second chemistry that is different than the first chemistry. The method also includes, based on receiving a request for additional propulsion, connecting the supplemental battery assembly and supplying additional power to the electrical motor, and based on a state of charge (SOC) of the propulsion battery assembly being below a SOC threshold, providing electrical charge to the propulsion battery assembly from the supplemental battery assembly.

In addition to one or more of the features described herein, the mixed chemistry battery system includes a third battery assembly including a battery cell having a third chemistry that is different than the first chemistry and the second chemistry, the battery cell connected in series to the propulsion battery assembly.

In addition to one or more of the features described herein, the supplemental battery assembly is a high energy battery assembly having an energy density that is greater than an energy density of the propulsion battery assembly.

In addition to one or more of the features described herein, the mixed chemistry battery system includes a DC-DC converter connected in parallel to the propulsion battery assembly and the supplemental battery assembly, the DC-DC converter configured to adjust an output voltage of the supplemental battery assembly.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a mixed chemistry battery system that includes battery assemblies having different chemistries, in accordance with an exemplary embodiment;

FIG. 2 depicts a mixed chemistry battery system connected to a propulsion system of a vehicle, in accordance with an exemplary embodiment;

FIGS. 3A and 3B depict operating states of a mixed chemistry battery system, in accordance with an exemplary embodiment;

FIG. 4 is a flow diagram depicting aspects of a method of controlling power transfer among battery systems during vehicle operation, in accordance with an exemplary embodiment;

FIG. 5 schematically illustrates components of a mixed chemistry battery system, and depicts aspects of a charging method, in accordance with an exemplary embodiment;

FIG. 6 is a flow diagram depicting aspects of a method of charging one or more components of a mixed chemistry battery system, in accordance with an exemplary embodiment;

FIG. 7 depicts an example of a battery assembly including battery cells having different chemistries, in accordance with an exemplary embodiment; and

FIG. 8 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments, methods, devices and systems are provided for energy storage and/or energy transfer using battery systems having multiple chemistries. An embodiment of a mixed chemistry battery system of a vehicle includes a propulsion battery system having a first chemistry (e.g., lithium iron phosphate or LFP) and a supplemental battery system having a second chemistry. For example, the supplemental battery system includes a high energy density (as compared to the propulsion battery system) battery assembly, such as a lithium metal battery (LMB) chemistry. The supplemental battery system is selectively connected in parallel to the propulsion battery system, and is operable to perform functions such as providing additional power to a vehicle propulsion system and extending vehicle range.

In an embodiment, the propulsion battery system (e.g., a high voltage battery pack or packs) is connected in series to a third battery system having a different chemistry than the propulsion battery system. For example, the third battery system includes one or more cells or modules having a nickel manganese cobalt (NCM) chemistry. The third battery system provides benefits that include increased overall energy density, improved low temperature performance, and improved estimation of state of charge of the propulsion battery system (e.g., LFP cells).

Embodiments also include systems and methods for controlling charging of components of a mixed chemistry battery system. In an embodiment, a system includes a controller configured to control a charging process. The charging process allocates charge to the battery systems based on a predictive control methodology that utilizes a model of the battery systems to predict state of charge and/or other parameters, and controls a charging current to apply the charging current at an optimal level that improves or maximizes charging efficiency under selected constraints.

Embodiments described herein present numerous advantages and technical effects. The embodiments provide for effective use of advanced and high energy density batteries to supplement existing battery storage and improve vehicle performance and range. The embodiments utilize the benefits of different chemistries to improve overall performance.

For example, lithium-based battery cells such as LFP cells are low in cost and have a relatively high cycle life, but have a relatively low energy density and are affected by low temperatures. Lithium-metal cells such as NCM cells, or other advanced battery chemistries, have relatively high energy densities but typically have shorter life cycles and reduced charging performance (e.g., charge rate) as compared to typical propulsion battery chemistries. Embodiments address such limitations by combining battery chemistries to improve the overall energy density, cycle life and charging performance.

In addition, it can be challenging to estimate the state of charge (SOC) of LFP cells. Inclusion of a series connected third battery system as described herein can significantly improve the ability to accurately estimate SOC.

The embodiments are not limited to use with any specific vehicle and may be applicable to various contexts. For example, embodiments may be used with automobiles, trucks, aircraft, construction equipment, farm equipment, automated factory equipment and/or any other device or system for which additional thermal control may be desired to facilitate a device or system's existing thermal control capabilities or features.

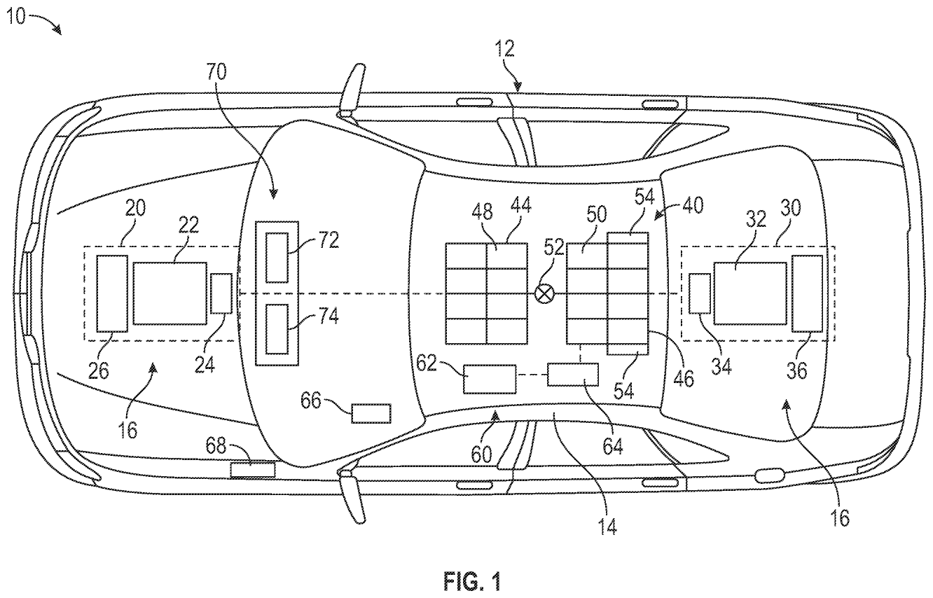

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and if the vehicle is a hybrid electric vehicle, a fuel injection subsystem, an exhaust subsystem and others.

The vehicle 10 may be an electrically powered vehicle (EV), a hybrid vehicle or any other vehicle. In an embodiment, the vehicle 10 is an electric vehicle, which includes one or more motors and one or more drive systems. For example, the propulsion system 16 is a multi-drive system that includes a first drive unit 20 and a second drive unit 30. The first drive unit 20 includes a first electric motor 22 and a first inverter 24, as well as other components such as a cooling system 26. The second drive unit 30 includes a second electric motor 32 and a second inverter 34, and other components such as a cooling system 36. The inverters 24 and 34 (e.g., traction power inverter units or TPIMs) each convert direct current (DC) power from a high voltage (HV) battery system to poly-phase (e.g., two-phase, three-phase, six-phase, etc.) alternating current (AC) power to drive the motors 22 and 32.

In the propulsion system 16, the drive unit 20 and the drive unit 30 are electrically connected to a mixed chemistry battery system 40. The battery system 40 or components thereof may be configured as a rechargeable energy storage system (RESS).

The mixed chemistry battery system 40 includes one or more battery assemblies. For example, the battery system 40 includes one or more high voltage battery packs, such as a first battery pack 44 connected to the inverter 24, and a second battery pack 46 connected to the inverter 34. The battery packs 44 and 46 (and associated components such as a RESS or battery management system (BMS) controller) are a primary source of power to the propulsion system 16, and are referred to as a propulsion battery system.

The battery pack 44 includes a plurality of battery modules 48, and the battery pack 46 includes a plurality of battery modules 50. Each module 48, 50 includes a number of individual cells (not shown). In an embodiment, the battery packs 44 and 46 can be independently charged and can be used to independently supply power for propulsion, power supply and/or charging.

Each battery module 48, 50 includes a plurality of cells (not shown) having a selected chemistry. In an embodiment, each cell is a lithium-ion battery, such as a lithium ferro-phosphate (LFP) battery. The battery packs 44 and 46 are not so limited and can have any suitable chemistry. Other examples include nickel-metal hydride and lead acid chemistries.

The mixed chemistry battery system 40 can be configured to provide different output voltage levels. For example, a battery switching device 52 is included for selectively connecting the battery pack 44 to the battery pack 46 in series to provide a relatively high voltage. The battery switching device 52 can also be operated to connect the battery packs in parallel to provide a relatively low voltage.

The vehicle 10 includes a number of additional battery assemblies (e.g., one or more additional cells, modules, packs etc.). In an embodiment, the mixed chemistry battery system 40 includes a supplemental battery system 60 that is connected or selectively connectable in parallel to the battery packs 44 and 46. The supplemental battery system 60 is provided to supplement the battery packs 44 and 46, for example, by providing additional power to the propulsion system 16 and/or providing energy to the battery pack 44 and/or 46 to increase the range of the vehicle 10. The supplemental battery system 60 includes at least one supplemental battery pack 62, which may have the same voltage rating as the battery packs 44 and 46 (e.g., 400V) but is not so limited.

The supplemental battery pack 62 is connected to the battery system 40 via a conversion device, such as a DC-DC converter 64. Control of the DC-DC converter 64 and/or the supplemental battery system 60 can be performed using any suitable processing device or processor, such as a battery management system (BMS) controller or other controller associated with the battery packs 44 and 46, a charging controller, a motor controller or others.

The supplemental battery system 60, in an embodiment, is a high energy density system (i.e., has a higher energy density than the battery packs 44 and 46). For example, the battery pack 62 includes a plurality of high energy density cells. Such cells have high energy density chemistries, such as Lithium-metal cells (e.g., LMB cells), Si-anode cells (lithium ion cells having silicon-based anodes) and others.

In an embodiment, the vehicle 10 includes one or more additional cells 54 that are connected in series to the cells of the battery pack 46 (and may also be connected in series to the battery pack 44 when the battery switching device 52 is closed). Although the cells 54 are shown as connected to the battery pack 46, one or more cells 54 may also be connected in series with the battery pack 44. It is noted that embodiments are not limited to the number or configuration of cells 54 shown in FIG. 1.

In an embodiment, the cells 54 have a battery chemistry that is different than the chemistry of the battery pack 44 and/or 46. For example, the cells 54 are NCM cells and the battery packs 44 and 46 have a lithium-ion chemistry, such as LFP.

The cells 54 may have various uses and functions. The cells 54 provide improvements in low temperature performance, and may be used as “virtual sensors” to facilitate estimation of the SOC of the battery pack 46. SOC estimation may be performed by estimating an SOC of the cells 54, and estimating the SOC of the battery pack 46, via known techniques such as coulomb counting. The estimates are combined to reduce the error of an estimation of SOC of the battery pack 46 (e.g., to 3% or less).

The vehicle 10 also includes a charging system, which can be used to charge the battery packs 44 and 46 (and cells 54), charge the supplemental battery system 60 and/or to supply power to charge another energy storage system (e.g., vehicle-to-vehicle (V2V) and/or vehicle-to-everything (V2X) charging). The charging system includes one or more conversion devices for controlling aspects of charging and/or discharging. For example, at least one conversion device provides for conversion between AC current and DC current and/or voltage control. The conversion device may be a bi-directional conversion device that allows a charge port to be used for either charging or discharging.

In an embodiment, the charging system includes a charging control device 66, such as an onboard charging module (OBCM). The charging control device 66 includes a conversion device in the form of a charger (charge circuit) that includes devices for alternating current (AC)-DC conversion and DC-DC conversion. For example, the charging control device 66 permits both charging and discharging to and from an external power storage device, such as the battery system of another vehicle (V2V charging). The charging control device 66 connects the battery system 40 to a charge port 68 for charging vehicle battery systems and/or providing charge to external storage systems.

The vehicle 10 also includes a computer system 70 that includes one or more processing devices 72 and a user interface 74. The various processing devices and units may communicate with one another via a communication device or system, such as a controller area network (CAN) or transmission control protocol (TCP) bus.

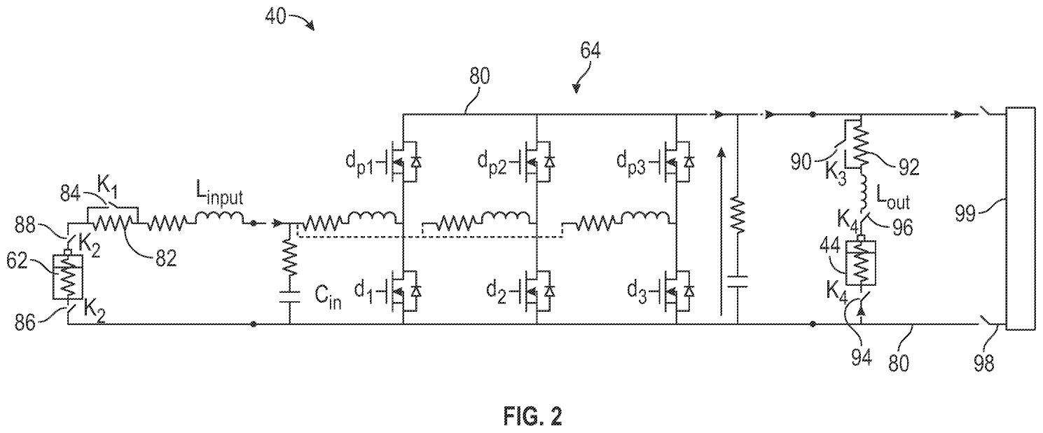

FIG. 2 depicts an embodiment of the mixed chemistry battery system 40. The battery pack 62 of the supplemental battery system 60 is connected in parallel to the DC-DC converter 64 and the battery pack 44. The system 40 has a topology that allows for different operating modes.

The battery pack 62 and the propulsion battery system (including, e.g., the battery pack 44 and/or the battery pack 46) are connected in parallel by a supplemental power bus 80. Although only the battery pack 44 is shown in FIG. 2, it is understood that the battery pack 46 can be similarly connected.

The supplemental battery pack 62 is selectively connectable to the DC-DC converter 64 and the bus 80 by a circuit that includes a resistor 82 and a pre-charge switch 84 (K1), an inductor Linput and a capacitor Cin. The supplemental battery pack 62 and the circuit can be connected and disconnected via a negative side switch 86 and a positive side switch 88 (switches K2).

The battery pack 44 is selectively connectable to the DC-DC converter 64 and the bus 80 by an inductor Lout and a pre-charge circuit that includes a switch 90 (K3) and a resistor 92. The battery pack 44 can be connected and disconnected from the bus 80 by a negative side switch 94 and a positive side switch 96 (switches K4).

The DC-DC converter 64 is configured to step up or step down voltage, for example, when the supplemental battery pack 62 is being charged or when the supplemental battery pack 62 is supplying power for propulsion. The DC-DC converter 64 can transmit power in both directions. In an embodiment, the DC-DC converter includes a half bridge circuit including switches dp1, d1, dp2, d2, dp3 and d3.

Any of the switches described may be any suitable type of switch, such as a mechanical contactor, electronic switch or solid state switching device. Any suitable solid state or electronic device may be employed as a switch. For example, switches can include solid state relays or transistors such as Silicon (Si) insulated gate bipolar transistors (IGBTs), and field-effect transistors (FETs). Examples of FETs include metal-oxide-semiconductor FETs (MOSFETs), Si MOSFETs, silicon carbide (Sic) MOSFETs, gallium nitride (GaN) high electron mobility transistors (HEMTs), and SiC junction-gate FETs (JFETs). Other examples of switches that can be used include diamond, gallium oxide and other wide band gap (WBG) semiconductor-based power switch devices.

As noted above, the mixed chemistry battery system 40 is configured for operation according to various operating modes. The operating modes include, for example, a normal propulsion mode, a range assist mode and a power assist mode.

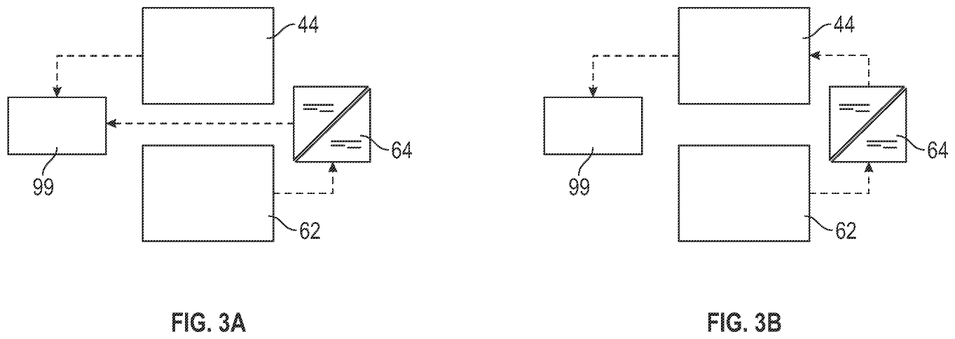

In the normal propulsion mode, the switches 86 and 88 are open, and the battery pack 44 (and/or the battery pack 46) operates normally to provide power for propulsion and/or supply power to vehicle components (loads). For example, in the normal propulsion mode, the battery system 40 provides three-phase AC current to a vehicle propulsion system via a propulsion bus 98 (and conversion devices such as a DC-DC converter and an inverter (not shown)). Various motors, components, the propulsion bus and the charger are collectively represented in FIGS. 3A and 3B by an element 99.

In the power assist mode, both the battery pack 44 and the supplemental battery pack 62 are connected to the bus 80 (switches K2 and K4 are closed). The battery pack 62 provides additional energy for propulsion, for example when a driver requests additional power.

For example, as shown schematically in FIG. 3A, in the power assist mode, the propulsion battery pack 44 provides current to the motor 22 and/or 32 via the inverter 24 and/or the inverter 34 (represented by the element 99). Current from the supplemental battery pack 62 flows through the DC-DC converter 64, which can be controlled in this mode to adjust an output voltage as desired, for example, to equalize the voltages of the battery pack 44 and the battery 62. Current flowing from the DC-DC converter 64 bypasses the battery pack 44 and is provided to the propulsion bus 98 (represented by element 99).

In the range assist mode, the supplemental battery pack 62 is connected in series to the battery pack 44, and operates during propulsion to provide charge to the battery pack 44 to maintain the battery pack 44 at or above a desired SOC. In the range assist mode, the supplemental battery pack 62 provides energy to the battery pack 44 via the DC-DC converter 64, to maintain the SOC of the battery pack 44 at a certain level. Current flows from the supplemental battery pack 62 through the DC-DC converter 64 and into the battery pack 44.

As shown schematically in FIG. 3B, in the range assist mode, the propulsion battery pack 44 provides current to the propulsion bus 98, and the supplemental battery pack 62 is connected in series with the battery pack 44 to provide charge thereto when needed or requested. For example, when the control device 66 detects that the battery pack 44 SOC is below some threshold charge level, or a request is received, current from the supplemental battery pack 62 is caused to flow through the DC-DC converter 64, which can be controlled in this mode to adjust an output voltage as discussed herein. The current from the DC-DC converter flows to the battery pack 44 and charges the battery pack 44.

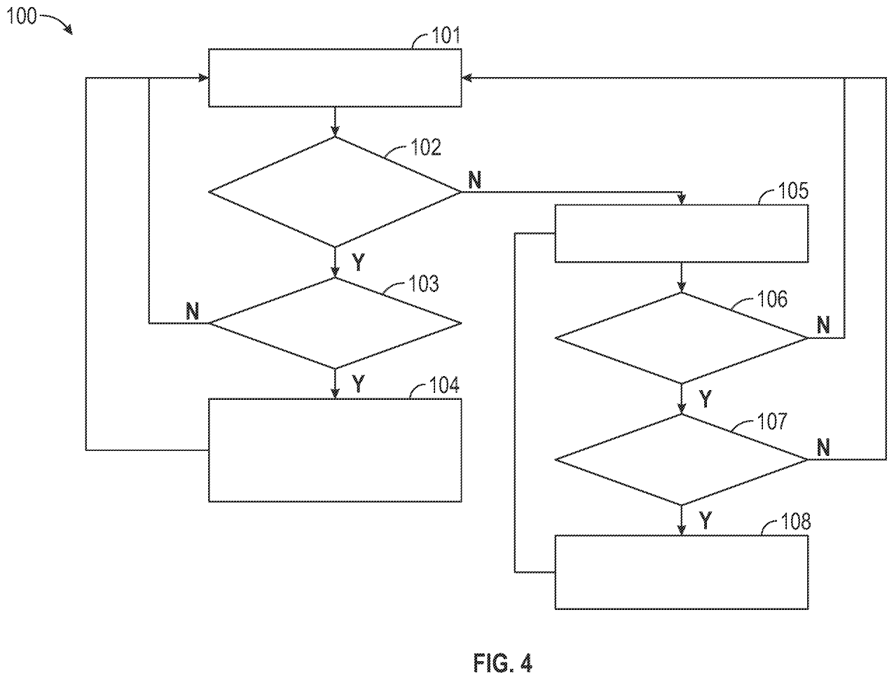

FIG. 4 depicts an embodiment of a method 100 of transferring power among and/or from battery systems having different chemistries. Aspects of the method 100 may be performed by a processor or processors disposed in a vehicle, such as the control device 66. It is noted the method 100 is not so limited and may be performed by any suitable processing device or system, or combination of processing devices.

The method 100 includes a number of steps or stages represented by blocks 101-108. The method 100 is not limited to the number or order of steps therein, as some steps represented by blocks 101-108 may be performed in a different order than that described below, or fewer than all of the steps may be performed.

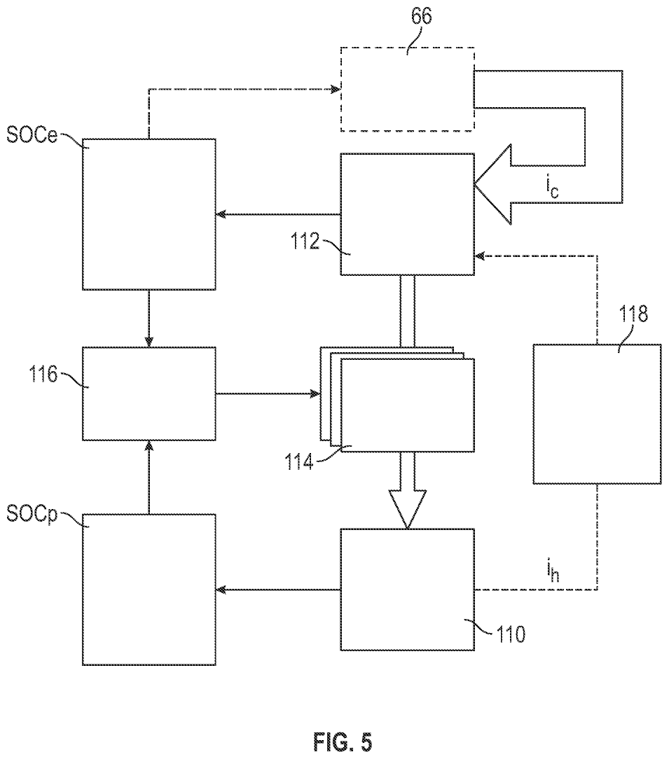

The method 100 is described in conjunction with the vehicle 10 of FIG. 1 and the topology of FIG. 5 for illustration purposes. The method 100 is not so limited and can be used with any suitable vehicle battery system and any suitable mixed chemistry battery system.

At block 101, the processing device monitors the vehicle 10 and the amount of power requested by a driver. At block 102, the processing device determines whether the power demand exceeds a threshold. The power demand threshold may be related to a maximum power output or power limit of the battery pack 44 and/or the battery pack 46.

At block 103, if the requested power exceeds the power demand threshold, the processing device determines the SOC of the supplemental battery pack 62. If the supplemental battery pack SOC is above a minimum SOC or SOC threshold, at block 104, the processing device sets the mixed chemistry battery system 40 to the power assist mode as discussed above, and both battery packs 44 and 64 provide power for propulsion. If the supplemental battery pack SOC is at or below the minimum SOC or SOC threshold, the method returns to block 101.

At block 105, if the requested power does not exceed the power demand threshold, the processing device determines the SOC of the battery pack 44. At block 106, the SOC of the battery pack 44 is compared to a SOC threshold. If the SOC is at or above the SOC threshold, the method returns to block 101.

At block 107, if the SOC of the battery pack 44 is below the SOC threshold, the processing device compares the SOC of the battery pack 62 to a selected threshold level. If the SOC of the battery pack 62 is below the selected threshold level, the method returns to block 101.

At block 108, if the SOC of the battery pack 62 is at or above the selected threshold level, the processing device sets the mixed chemistry battery system 40 to the range assist mode as discussed above, in which the supplemental battery pack 62 is connected in series to the battery pack. Energy is then transferred to the battery pack 44 until the battery pack reaches a desired SOC and/or is maintained at or above a target SOC of the battery pack 44.

As previously noted, mixed chemistry battery systems described herein can be used to facilitate charging processes. FIG. 5 illustrates the flow of energy among vehicle components during a charging operation. The charging operation is performed using a control method or algorithm that allows for simultaneous or concurrent charging of both a propulsion battery system and a supplemental battery system.

In an embodiment, the charging operation is performed based on prioritizing charging of the propulsion battery system, such that available power is provided to the propulsion battery subject to charging constraints used to protect the propulsion battery pack or packs. Any remaining power (i.e., power not needed to charge the propulsion battery) is provided to charge the supplemental battery system.

In FIG. 5, power flow and communication are shown schematically. The propulsion battery system is configured as a power module 110 that includes a propulsion battery assembly such as the battery pack 44 and at least one cell 54. An energy module 112 includes a supplemental battery assembly such as the supplemental battery pack 62. At least one bi-directional DC-DC converter 114 (isolated or non-isolated) is connected between the power module 110 and the energy module 112.

The control device 66 controls power flow during charging. In an embodiment, the control device 66 is a predictive controller that performs a model predictive control (MPC) method. The MPC is based on a model of the propulsion system and the supplemental battery system, and is selected to allow the control device 66 to simulate parameters of the systems and make predictions that are used for control of the charging process.

During charging, the battery pack 62 and the battery pack 44 are connected to the charging bus 80, and a charging current i_{c} is provided to the charging bus 80. The charging current is adjusted based on control signals provided from the control device 66.

In an embodiment, a heat source is employed to allow for heating the energy module 112 in order to improve charging performance. This is useful in contexts such as low temperature environments or seasons. For example, chemistries such as LMB are more favorable to accept higher charging rates when the cells are warm (e.g., at or above about 50 degrees Celsius). The power module 110 can be used to provide energy to heat the cells in the energy module 112, or a separate heating device can be used to heat the energy module 112.

In an embodiment, the power module 110 is configured to heat the energy module 112 by applying an AC heating current in thereto. The heating current is controlled by a controller 118. The heating current in can be used to raise the temperature of the energy module 112, so that the cells therein can be charged with a higher charging rate.

During a charging process, measurements of current, voltage and temperature from the modules 110 and 112 are acquired. The control device 66 generates or acquires estimations of the SOC (denoted SOCe) and state of power (SOP) for the energy module 112, and also generates or acquires estimations of the SOC (denoted SOCp) and state of power (SOP) for the power module 110. The estimations are based on the charging current, and measured voltages and temperatures.

In an embodiment, the estimations of SOC and SOP are predictions that are used by the controller 116 in real time to determine a desired charging current i_{c}. The predictions are acquired by applying measurements to a mathematical model that simulates parameters of the energy module 112 and the power module 110. The predictions are used by the controller using model predictive control (MPC) to determine an optimal value of the charging current. The optimal value is a value produced by minimizing a cost function while satisfying constraints.

In an embodiment, the mathematical model is a quasi-steady state model that simulates SOC and temperature of the modules. Embodiments are not so limited, as other types of models may be utilized. Examples of such models include steady state models and lookup table-based models.

The following equations represent an example of a quasi-steady state model:

$${q}_{e} ( t + Δ T ) = {q}_{e} ( t ) - \frac{1}{{Q}_{e}} {pi}_{L} ( t ) Δ T + \frac{1}{{Q}_{p}} {i}_{c} ( t ) Δ T$$

$${q}_{p} ( t + Δ T ) = {q}_{p} ( t ) + \frac{1}{{Q}_{p}} {pi}_{L} ( t ) \frac{{V}_{e} ( t )}{{V}_{p} ( t )} Δ T - \frac{1}{{Q}_{p}} {i}_{h} ( t ) Δ T$$

$$T ( t + Δ T ) = ( 1 - \frac{Δ T}{{m}_{b} {C}_{p}^{b}} hA ) T ( t ) + \frac{Δ T}{{m}_{b} {C}_{p}^{b}} {hAT}_{amb} + \frac{Δ T}{{m}_{b} {C}_{p}^{b}} {V}_{p} ( t ) {i}_{h} ( t )$$

In the above equations, t is time and ΔT is a change in temperature of the energy module 112 as compared to a previous time step or previous prediction. i_{c} is the charging current, i_{L} is the current through the inductor Linput, and in is the heating current. qₑ is the SOC of the energy module 112, qₑ is the SOC of the energy module 112, and T is the temperature of the energy module 112. Qₑ and Qₚ are the respective capacities of the energy module 112 and the power module 110.

p is a variable relating to each phase of AC current provided for propulsion, and is defined as a number of the DC-DC converters 114 connected in parallel. mb is the mass of the energy module 112. Cp^{b} is specific heat, h is a heat transfer coefficient and A is surface area. Vₑ and Vₚ are voltage of the energy module 112 and the power module 110, respectively.

qₑ (t) represents qₑ at a given time step or time, and qₑ (t+ΔT) represents a prediction of qₑ given the change in temperature. Similarly, qₚ (t) represents qₚ at time t and qₑ (t+ΔT) represents a prediction of qₚ, and T (t+ΔT) represents a prediction of the temperature of the energy module 112.

The control device 66 controls the charging current, the inductor current and the heating current (if used) to maintain these currents within the following constraints:

$$0 \leq {i}_{L} ( t ) , 0 \leq {i}_{h} ( t ) , 0 \leq {i}_{c} ( t )$$

$$- {i}_{Energy}^{max} ( T ) \frac{1}{p} \leq {i}_{L} ( t ) - \frac{1}{p} {i}_{c} ( t ) \leq - {i}_{Energy}^{min} ( T ) \frac{1}{p} ,$$

$${i}_{Power}^{min} \frac{{V}_{2} ( t )}{{pV}_{1} ( t )} \leq {i}_{L} ( t ) + \frac{{V}_{2} ( t )}{{pV}_{1} ( t )} {i}_{h} ( t ) \leq {i}_{Power}^{max} \frac{{V}_{2} ( t )}{{pV}_{1} ( t )} ,$$

where i^{max}_{energy}(T) and i^{min}_{energy}(T) are a maximum allowed current and a minimum current through the energy module 112 at a temperature T. i^{max}_{power} and i^{min}_{power} are a maximum allowed current and a minimum current through the power module 110.

To maintain the performance of the system within these constraints, the control device 66 determines values of the currents that minimize a cost function J:

$$J = {\sum }_{k = 1}^{N} ( y ( k ) + {R}_{u} ( k ) ) , where$$

$$y ( k ) = {{w}_{1} ( {q}_{e} ( k ) - 1 )}^{2} + {{w}_{2} ( {q}_{p} ( k ) - 1 )}^{2}$$

$${R}_{u} ( k ) = {w}_{3} {i}_{L}^{2} + {w}_{4} {i}_{h}^{2} + {w}_{5} {i}_{c}^{2} .$$

In the above, k is a time step or control interval, and N is a selected finite horizon (e.g., number of successive intervals k). w₁ and w₂ are weighting coefficients for qₑ and qₚ, respectively. w₃, w₄ and w₅ are weighting coefficients for iₜ, iₕ and i_{c}, respectively. The weights can be selected to adjust the importance or weight given to a respective parameter when optimizing the various currents.

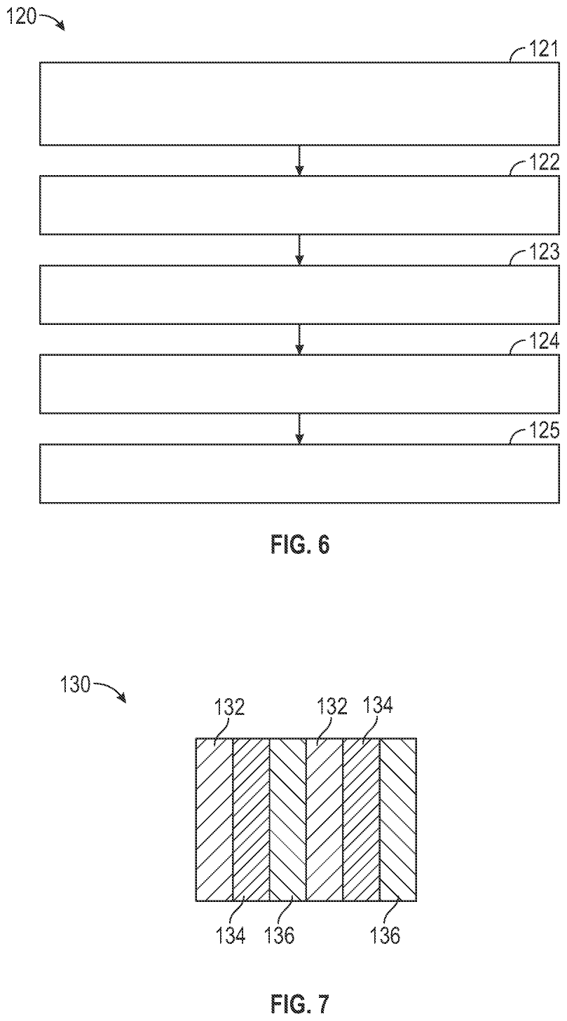

FIG. 6 illustrates an embodiment of a method 120 of charging a battery system of a vehicle. Aspects of the method 120 may be performed by a processor or processors disposed in a vehicle, such as a BMS controller. It is noted the method 120 is not so limited and may be performed by any suitable processing device or system, or combination of processing devices.

The method 120 includes a number of steps or stages represented by blocks 121-125. The method 120 is not limited to the number or order of steps therein, as some steps represented by blocks 121-125 may be performed in a different order than that described below, or fewer than all of the steps may be performed.

The method 120 is described in conjunction with the vehicle 10 of FIG. 1, the mixed chemistry battery system 40 of FIG. 2 and the schematic of FIG. 5, for illustration purposes. The method 120 is not so limited and can be used with any suitable vehicle battery system and any suitable charging system.

At block 121, a charging process is initiated. The charging process many be initiated by putting the vehicle 10 into a charging mode and connecting the charge port 68 to a power source. The power source may be a charging station, electrical grid, another vehicle or other suitable source of energy. The controller can communicate with the power source, for example, over a charging cable or wirelessly.

The controller determines various charging parameters such as the nominal battery voltage of the power module 110 and the energy module 112, initial temperature, maximum allowable charge current and desired charge energy.

At block 122, the controller inputs charging parameters to a mathematical model of components used in the charging process. In an example, the mathematical model is a quasi-steady state model as discussed above, or any other suitable model that allows for simulation, prediction of estimation of the state of charge, temperature and/or other parameters or conditions of the modules.

At block 123, a charging current i_{c} is applied to the power module 110. During the charging, measurements of current, voltage and temperature of the modules are taken and provided to the model. Measurements may be performed continuously or periodically at a plurality of successive sampling times or time steps.

At block 124, the controller applies the measurements to the model at each time step to predict the state of charge of the power module 110. The controller then determines an optimal charging current that stays within selected constraints and minimizes a cost function as described herein.

The controller periodically controls the charging current to conform to the optimal charging current.

At block 125, when the predicted or estimated state of charge reaches a desired level, the controller disconnects the power module 110 from the charging bus 80, or otherwise stops providing energy to charge the power module 110. The energy module 112 is then charged for a selected amount of time, or until the energy module 112 reaches a desired SOC. During charging of the energy module 112, the controller continues to measure battery parameters and determine an optimal charging current by minimizing a cost function as described herein.

In an embodiment, the power module 110 and the energy module 112 are charged simultaneously. For example, the DC-DC converter 64 is a partial power processor, or the mixed chemistry battery system otherwise includes components that allow parts of the total charging power to be allocated to the energy module and the power module. In this embodiment, the controller determines an amount of power needed to charge the power module 110, and directs that amount of power to the power module 110. Any remaining power is directed to the energy module 112.

The various battery systems describes herein may be packaged or arranged in any suitable manner. In an embodiment, the battery systems are arranged (e.g., as part of a battery module or power module) so that temperature is distributed, so that the temperature of a given cell or module does not exceed a desired threshold.

FIG. 7 depicts an example of a hybrid battery pack 130 that includes multiple cells having different chemistries. In this example, the hybrid battery pack includes LFP cells 132 (e.g., cells of the battery pack 44 and/or 46) and NCM cells 134 (e.g., the cells 54 of FIG. 1). The battery pack also includes LMB cells 136, which may be cells of the battery pack 62 of FIG. 1.

In this example, the temperature is distributed according to a pattern that evenly distributes the different chemistries. The pattern in an embodiment, is selected such that individual cells having the same chemistry are not adjacent to each other. The pattern shown in FIG. 7 is an example, as other patterns of distributing different cell chemistries may be used. In some cases, it may be preferable to incorporate thermal barriers.

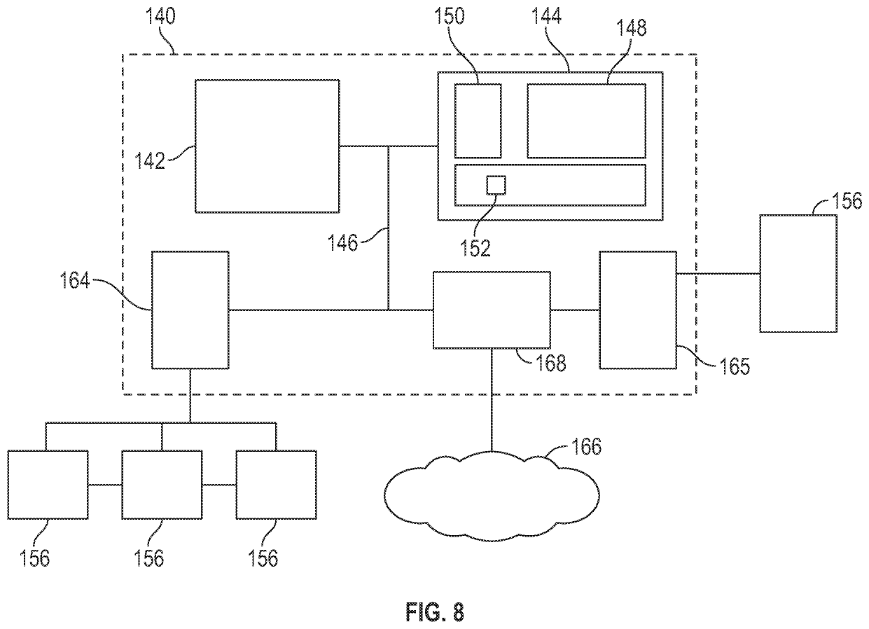

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to control of power transfer as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for controlling power transfer, comprising:
a propulsion battery assembly configured to supply power to an electric motor of a vehicle, the propulsion battery assembly having a first chemistry;
a supplemental battery assembly selectively connected to the propulsion battery assembly, the supplemental battery assembly having a second chemistry that is different than the first chemistry; and
a controller configured to selectively connect the supplemental battery assembly to perform at least one of: providing electrical charge to the propulsion battery assembly, and supplying electrical power to the electric motor.

2. The system of claim 1, further comprising a third battery assembly including a battery cell having a third chemistry that is different than the first chemistry and the second chemistry, the battery cell connected in series to the propulsion battery assembly.

3. The system of claim 1, wherein the supplemental battery assembly is a high energy battery assembly having an energy density that is greater than an energy density of the propulsion battery assembly.

4. The system of claim 1, further comprising a DC-DC converter connected in parallel to the propulsion battery assembly and the supplemental battery assembly, the DC-DC converter configured to adjust an output voltage of the supplemental battery assembly.

5. The system of claim 4, wherein the controller is configured to connect the supplemental battery assembly in series to the propulsion battery assembly, and provide the electrical charge to the propulsion battery assembly through the DC-DC converter during vehicle propulsion to extend a range of the vehicle.

6. The system of claim 5, wherein the controller is configured to connect the supplemental battery assembly based on a state of charge (SOC) of the propulsion battery assembly being below a SOC threshold, and provide the electrical charge to maintain the SOC of the propulsion battery assembly at or above the SOC threshold.

7. The system of claim 4, wherein the controller is configured to connect the supplemental battery assembly in parallel to the propulsion battery assembly, and provide the electrical power to the electric motor through the DC-DC converter, the electrical power bypassing the propulsion battery assembly.

8. The system of claim 1, wherein the vehicle is configured to be connected to a power source for charging of the propulsion battery assembly, and the controller is configured to control a charging process that prioritizes providing charging power to the propulsion battery assembly.

9. The system of claim 8, wherein the charging process includes providing an amount of power to charge the propulsion battery assembly to a desired SOC, and providing a remaining amount of power to charge the supplemental battery assembly.

10. The system of claim 8, wherein the controller is configured to control the charging process based on a predictive control methodology that includes predicting a state of charge of the propulsion battery assembly and the supplemental battery assembly based on a quasi-steady state model.

11. A method of controlling power transfer, comprising:
monitoring, by a controller, a propulsion system of a vehicle, the propulsion system connected to a mixed chemistry battery system, the mixed chemistry battery system including a propulsion battery assembly configured to supply power to an electric motor of the propulsion system, and a supplemental battery assembly selectively connected to the propulsion battery assembly, the propulsion battery assembly having a first chemistry and the supplemental battery assembly having a second chemistry that is different than the first chemistry;
based on receiving a request for additional propulsion, connecting the supplemental battery assembly and supplying additional power to the electrical motor; and
based on a state of charge (SOC) of the propulsion battery assembly being below a SOC threshold, providing electrical charge to the propulsion battery assembly from the supplemental battery assembly.

12. The method of claim 11, wherein the mixed chemistry battery system includes a third battery assembly including a battery cell having a third chemistry that is different than the first chemistry and the second chemistry, the battery cell connected in series to the propulsion battery assembly.

13. The method of claim 11, wherein the supplemental battery assembly is a high energy battery assembly having an energy density that is greater than an energy density of the propulsion battery assembly.

14. The method of claim 11, wherein the mixed chemistry battery system includes a DC-DC converter connected in parallel to the propulsion battery assembly and the supplemental battery assembly, the DC-DC converter configured to adjust an output voltage of the supplemental battery assembly.

15. The method of claim 14, wherein providing the electrical charge to the propulsion battery assembly includes connecting the supplemental battery assembly in series to the propulsion battery assembly, and providing the electrical charge to the propulsion battery assembly through the DC-DC converter during vehicle propulsion to extend a range of the vehicle.

16. The method of claim 14, wherein supplying the additional power includes connecting the supplemental battery assembly in parallel to the propulsion battery assembly, and providing electrical power to the electric motor through the DC-DC converter, the electrical power bypassing the propulsion battery assembly.

17. A vehicle system comprising:
a memory having computer readable instructions; and
a processing device for executing the computer readable instructions, the computer readable instructions controlling the processing device to perform a method including:
monitoring, by a controller, a propulsion system of a vehicle, the propulsion system connected to a mixed chemistry battery system, the mixed chemistry battery system including a propulsion battery assembly configured to supply power to an electric motor of the propulsion system, and a supplemental battery assembly selectively connected to the propulsion battery assembly,
the propulsion battery assembly having a first chemistry; and
the supplemental battery assembly having a second chemistry that is different than the first chemistry;
based on receiving a request for additional propulsion, connecting the supplemental battery assembly and supplying additional power to the electrical motor; and
based on a state of charge (SOC) of the propulsion battery assembly being below a SOC threshold, providing electrical charge to the propulsion battery assembly from the supplemental battery assembly.

18. The vehicle system of claim 17, wherein the mixed chemistry battery system includes a third battery assembly including a battery cell having a third chemistry that is different than the first chemistry and the second chemistry, the battery cell connected in series to the propulsion battery assembly.

19. The vehicle system of claim 17, wherein the supplemental battery assembly is a high energy battery assembly having an energy density that is greater than an energy density of the propulsion battery assembly.

20. The vehicle system of claim 17, wherein the mixed chemistry battery system includes a DC-DC converter connected in parallel to the propulsion battery assembly and the supplemental battery assembly, the DC-DC converter configured to adjust an output voltage of the supplemental battery assembly.
